(19) United States
(12) Patent Application Publication
(10) Pub. No.: US 2007/0033011 A1
(43) Pub. Date: Feb. 8, 2007

(54) METHOD OF BAND GROUP PARTITION FOR WIDEBAND AUDIO CODEC

(76) Inventors: He Ouyang, Shanghai (CN); Binghui Wu, Shanghai (CN); Yi Zhou, Shanghai (CN); Lin Luo, Shanghai (CN); Kai Wan, Shanghai (CN)

Correspondence Address: SINORICA, LLC, 528 FALLSGROVE DRIVE, ROCKVILLE, MD, 20850, US

(21) Appl. No.: 11/458,207

(22) Filed: Jul. 18, 2006

(30) Foreign Application Priority Data
Aug. 3, 2005 (CN) 200510028406.1

(51) Int. Cl. G10L 19/14

(52) U.S. Cl. 704/205

(57) ABSTRACT

This invention discloses a method of frequency band group partition for wideband audio codec. It can determine the initial frequency band group partition within the whole effective range of frequency bands. It further subdivides frequency band groups based on the initial partition. Instead of the iteration-based algorithm, this invention applies the 1-from-2 and 1-from-3 criterions to accomplish the fast partition with at most 3 subdivisions. This invention implements the fast partition for frequency band group without the loss of the coding efficiency. By applying this fast partition method, one can greatly reduce the computational complexity and significantly improve the coding performance.

### FIELD OF THE INVENTION

The present invention relates generally a method of audio codec, especially a method of frequency band group partition for low-complexity and high-quality wideband audio codec.

### BACKGROUND OF THE INVENTION

Currently, audio coding technologies exhibit the rapid progress and are widely used. A low-complexity and high-quality wideband audio codec makes band group partition before the coding of quantized spectrum. FIG. 1 illustrates the concept of band group partition. Characteristics of band group partition result are as below:

1. 1˜4 band groups are allowed by partition;

2. Each band group is composed of a class-A band and a successive class-B band;

3. The maximum absolute quantized value of all the sub-bands in class-A band is 1, that is, the quantized value of each sub-band in class-A band is one of {+1, 0, −1};

4. The maximum absolute quantized value of all the sub-bands in class-B band is larger than 1, but the sub-bands with absolute value less than or equal to 1 may be included in class-B band;

5. As a special case, the class-A or class-B band may be absent in a band group.

Class-A and class-B bands use two different coding methods respectively. In general, the coding efficiency of class-A bands are higher than that of class-B bands. It has a significant impact on the coding efficiency to reasonably make the band group partition. For each quantized frame, the band group partition that has less coded bits is better. However, due to a considerable number of sub-bands (512 at most) for each frame, it is not computationally efficient to go through the whole band group. Moreover, in order to make the coded bits within a certain range, a number of iterations may be needed for coding each frame. Every time the quantized value of the spectrum changes, the band group is repartitioned. Hereby for the sake of improving coding efficiency, a fast method of band group partition is indispensable.

### SUMMARY OF THE INVENTION

The present invention is a method of band group partition for wideband audio codec. It implements the fast band group partition and improves the coding efficiency significantly.

The method is composed of the following steps:

Step 1, Partition all sub-bands below the cut-off frequency into one frequency band group, which includes one class-A band A0 and one class-B band B0; A0 is the maximum consecutive band whose absolute value of quantized spectrum is 0 or 1; All bands except A0 make up class-B bands; if B0 is absent, go to Step 1.1˜1.3, otherwise, go to Step 2;

Step 1.1, Calculate actual coded bits C₀₀ of the current partition {A0};

Step 1.2, Take half lower sub-band of A0 as class-B band and recalculate its corresponding coded bits C₀₁;

Step 1.3, If C₀₀ is less than C₀₁, code all the bands as class-A band; otherwise, take the partition in Step 1.2 as the final partition and conclude coding;

Step 2, Find bands conformed to the conditions of class-A band in B0 and take the band with the largest bandwidth as class-A band A1 in a new band group; If multiple class-A bands with the same bandwidth are present, choose the band with the highest frequency; the successive 4 bands form the 1^{st} band group {B0, A0} and 2^{nd} band group {B1, A1}; If A1 is present, go to Step 3; otherwise, go to Step 2.1˜2.3;

Step 2.1, Divide the class-B band in Step 2 into two bands B1, B0 with the equal bandwidth; Based on the partition B1, B0, calculate and determine the needed quantization tables T1, T0, which has the maximum bits of L1, L0 for the longest codeword respectively;

Step 2.2, If L1 is less than L0, scan B0 from left to right until the first sub-band f1 that can not be coded with the table T1, and take f1 as the starting frequency of B0;

Step 2.3, If L1 is larger than L0 or equal to L0, scan B1 from right to left until the first sub-band f1 that can not be coded with the table T0, and take f1 as the end frequency of B1;

Step 3, Calculate the coded bits C₁₀ based on the current band group partition;

Step 4, If the bandwidth of B0 is larger than 3, subdivide B0 into {B1, A1}, {B1n, A1n}, {B0, A0} following Step 2 and calculate the coded bits C₁₁; If C₁₁ is smaller than C₁₀, the new partition is kept, otherwise the original partition is hold.

Step 5, If the bandwidth of B1 is larger than 3, subdivide B1 into {B1n′, A1n′}, {B1, A1}, {B0, A0} following said Step 2 and correspondingly calculate the coded bits C₁₂; If C₁₂ is smaller than min{C₁₀, C₁₁}, the new partition is kept otherwise the partition by Step 4 is hold.

If Step 4 and Step 5 do not update the partition formed by Step 2, the partition by Step 2 is the final band partition.

If Step 4 and Step 5 update the partition formed by Step 2, renumber the 3 band groups as {B2, A2}, {B1, A1}, {B0, A0} from low to high frequency; find out the band with the highest bandwidth from these 3 class-B bands {B2, B1, B0}; if this bandwidth is larger than 3, subdivide this band following said Step 2 and calculate the corresponding coded bits; If number of these bits is smaller than that of the coded bits corresponds to the partition {B2, A2}, {B1, A1} and {B0, A0}, update the band partition to produce 4 band groups as the final band partition and conclude coding.

The present invention employs local extremum scanning in the band and adopts the strategy of multiple subdivisions, thus greatly reducing the number of band scanning and the computational load. The issues of the convergency and the converging speed do not exist due to the non-iterative algorithm used by this invention. The present invention can speed the partition and ensure the quality of partition.

### BRIEF DESCRIPTION OF THE DRAWINGS

FIG. 1 is diagram of band group partition;

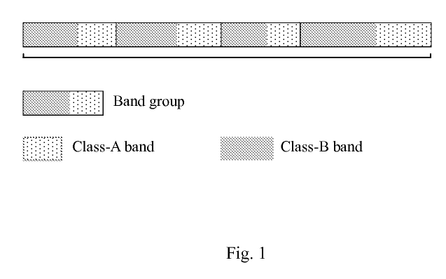

FIG. 2 is diagram of procedure of the band group partition in this invention, in which (a) is the spectrum of quantized frame, (b)˜(e) is the illustration of the band group partition;

FIG. 3 is diagram of the subdivision procedure for band B1 and B0 in FIG. 2(c), in which (a) illustrates the band subdivision for band B1, and (b) illustrates the band subdivision for band B0.

### DETAILED DESCRIPTION OF EMBODIMENTS

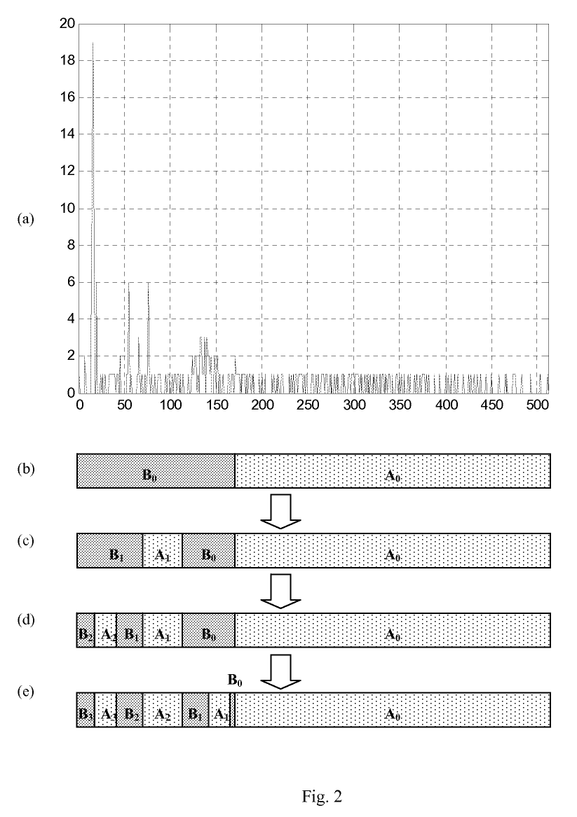

Refer to FIG. 2, the method provided by the present invention comprising:

Step 1, Partition all sub-bands below the cut-off frequency into one frequency band group, which includes one class-A band A0 and one class-B band B0; A0 is the maximum consecutive band whose absolute value of quantized spectrum is 0 or 1; All bands except A0 make up class-B bands; if B0 is absent, go to Step 1.1˜1.3, otherwise, go to Step 2;

Step 1.1, Calculate actual coded bits C₀₀ of the current partition {A0};

Step 1.2, Take half lower sub-band of A0 as class-B band and recalculate its corresponding coded bits C₀₁;

Step 1.3, If C₀₀ is less than C₀₁, code all the bands as class-A band; otherwise, take the partition in Step 1.2 as the final partition and conclude coding;

Step 2, Find bands conformed to the conditions of class-A band in B0 and take the band with the largest bandwidth as class-A band A1 in a new band group; If multiple class-A bands with the same bandwidth are present, choose the band with the highest frequency; the successive 4 bands form the 1^{st} band group {B0, A0} and 2^{nd} band group {B1, A1}; If A1 is present, go to Step 3; otherwise, go to Step 2.1˜2.3;

Step 2.1, Divide the class-B band in Step 2 into two bands B1, B0 with the equal bandwidth; Based on the partition B1, B0, calculate and determine the needed quantization tables T1, T0, which has the maximum bits of L1, L0 for the longest codeword respectively;

Step 2.2, If L1 is less than L0, scan B0 from left to right until the first sub-band f1 that can not be coded with the table T1, and take f1 as the starting frequency of B0;

Step 2.3, If L1 is larger than L0 or equal to L0, scan B1 from right to left until the first sub-band f1 that can not be coded with the table T0, and take f1 as the end frequency of B1;

Step 3, Calculate the coded bits C₁₀ based on the current band group partition;

Step 4, If the bandwidth of B0 is larger than 3, subdivide B0 into {B1, A1}, {B1n, A1n}, {B0, A0} following Step 2 and calculate the coded bits C₁₁; If C₁₁ is smaller than C₁₀, the new partition is kept, otherwise the original partition is hold.

Step 5, If the bandwidth of B1 is larger than 3, subdivide B1 into {B1n′, A1n′}, {B1, A1}, {B0, A0} following said Step 2 and correspondingly calculate the coded bits C₁₂; If C₁₂ is smaller than min{C₁₀, C₁₁}, the new partition is kept otherwise the partition by Step 4 is hold.

If Step 4 and Step 5 do not update the partition formed by Step 2, the partition by Step 2 is the final band partition.

If Step 4 and Step 5 update the partition formed by Step 2, renumber the 3 band groups as {B2, A2}, {B1, A1}, {B0, A0} from low to high frequency; find out the band with the highest bandwidth from these 3 class-B bands {B2, B1, B0}; if this bandwidth is larger than 3, subdivide this band following said Step 2 and calculate the corresponding coded bits; If number of these bits is smaller than that of the coded bits corresponds to the partition {B2, A2}, {B1, A1} and {B0, A0}, update the band partition to produce 4 band groups as the final band partition and conclude coding.

Please refer to FIG. 2. We will further interpret this invention with an example.

Suppose the spectrum of quantized frame is obtained as the FIG. 2(a).
(1) Scan the band and make band group partition. The result {B0, A0} is shown as FIG. 2(b), in which A0 is a class-A band, and B0 is a class-B band.
(2) Rescan B0 in FIG. 2(b) to find A1 which is a class-A band, and obtain the band group partition {B1, A1, B0, A1} as FIG. 2(c).
(3) Calculate and compare the coded bits produced by the band group partition in FIGS. 2(b) and 2(c). The number of coded bits of FIG. 2(c) is smaller, so the partition in FIG. 2(c) is kept as the foundation of further subdivision.

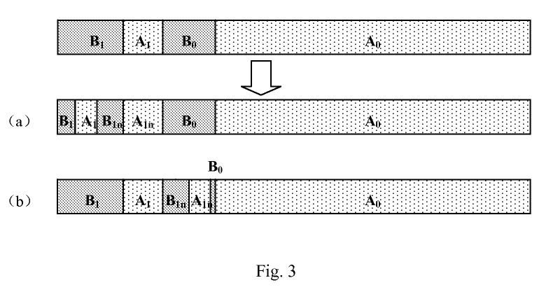

(4) Rescan B1 and B0 in FIG. 2(c) for possible band groups with smaller bandwidth, and obtain the partitions as FIGS. 3(a) and 3(b) respectively.

(5) Calculate and compare the coded bits produced by the band group partition in FIGS. 3(a) and 3(b). The bit-rate of FIG. 3(a) is smaller, so the partition in FIG. 3(a) is kept as the foundation of further subdivision. Rename each band group and obtain the partition as FIG. 2(d). Now 3 band groups are partitioned.
(6) Because Step (5) changes the partition of Step (3), further subdivision is required. Found the widest band in B2, B1 and B0. In this example, suppose B0 is widest.
(7) Subdivide B0 to 4 bands, and calculate the coded bits. Compare it with the number of coded bits based on the partition of FIG. 2(d).
(8) In this example, Step (7) obtains the smaller coded bit count, and the band group partition in FIG. 2(e) is taken as the final partition to code the current quantized frame.

What is claimed is:

1. A method of frequency band group partition for wideband audio codec, comprising following steps:
Step 1, Partition all sub-bands below cut-off frequency into one frequency band group, which includes one class-A band A0 and one class-B band B0; A0 is maximum consecutive band whose absolute value of quantized spectrum is 0 or 1; All bands except A0 make up class-B bands; if B0 is absent, go to Step 1.1˜1.3, otherwise, go to Step 2;
Step 1.1, Calculate actual coded bits C₀₀ of current partition {A0};
Step 1.2, Take half lower sub-band of A0 as class-B band and recalculate its corresponding coded bits C₀₁;
Step 1.3, If C₀₀ is less than C₀₁, code all the bands as class-A band; otherwise, take partition in Step 1.2 as the final partition and conclude current coding;
Step 2, Find bands conformed to the conditions of class-A band in B0 and take the band with the largest bandwidth as class-A band A1 in a new band group; If multiple class-A bands with the same bandwidth are present, choose the band with highest frequency; the successive 4 bands form the 1^{st} band group {B0, A0} and 2^{nd} band group {B1, A1}; If A1 is present, go to Step 3; otherwise, go to Step 2.1˜2.3;
Step 2.1, Divide the class-B band in Step 2 into two bands B1, B0 with the equal bandwidth; Based on the partition B1, B0, calculate and determine needed quantization tables T1, T0, which has the maximum bits of L1, L0 for the longest codeword respectively;
Step 2.2, If L1 is less than L0, scan B0 from left to right until first sub-band f1 that can not be coded with the table T1, and take f1 as the starting frequency of B0;
Step 2.3, If L1 is larger than L0 or equal to L0, scan B1 from right to left until the first sub-band f1 that can not be coded with the table T0, and take f1 as the end frequency of B1;
Step 3, Calculate the coded bits C₁₀ based on the current band group partition;
Step 4, If the bandwidth of B0 is larger than 3, subdivide B0 into {B1, A1}, {B1n, A1n}, {B0, A0} following Step 2 and calculate the coded bits C₁₁; If C₁₁ is smaller than C₁₀, the new partition is kept, otherwise the original partition is hold.

2. The method as described in claim 1, further comprising:
Step 5, If the bandwidth of B1 is larger than 3, subdivide B1 into {B1n′, A1n′}, {B1, A1}, {B0, A0} following said Step 2 and correspondingly calculate the coded bits C₁₂; If C₁₂ is smaller than min{C₁₀, C₁₁}, the new partition is kept otherwise the partition by Step 4 is hold.

3. The method as described in claim 1 or 2, If said Step 4 and said Step 5 do not update the partition formed by said Step 2, the partition by said Step 2 is the final band partition and conclude the current coding.

4. The method as described in claim 1 or 2, If said Step 4 and said Step 5 update the partition formed by said Step 2, renumber the 3 band groups as {B2, A2}, {B1, A1}, {B0, A0} from low to high frequency; find out the band with the highest bandwidth from these 3 class-B bands {B2, B1, B0}; if this bandwidth is larger than 3, subdivide this band following said Step 2 and calculate the corresponding coded bits; If number of these bits is smaller than that of the coded bits corresponds to the partition {B2, A2}, {B1, A1} and {B0, A0}, update the band partition to produce 4 band groups as the final band partition and conclude the current coding.
